(19) United States
(12) Patent Application Publication
(10) Pub. No.: US 2006/0261304 A1
(43) Pub. Date: Nov. 23, 2006

(54) Thermal management of electronic devices

(75) Inventors: Poongunran Muthukumaran, Worcester, MA (US); Nurten E. Emek, Methuen, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels, Inc., Northborough, MA (US)

(21) Appl. No.: 11/268,669

(22) Filed: Nov. 7, 2005

Related U.S. Application Data
(60) Provisional application No. 60/625,384, filed on Nov. 5, 2004.
(60) Provisional application No. 60/676,272, filed on Apr. 29, 2005.

(51) Int. Cl. E04B 1/74; H01M 8/04

(52) U.S. Cl. 252/62; 429/26

(57) ABSTRACT

Embodiments of the present invention describe an insulated electronic device comprising a heat generating component at least partially covered with at least one layer of a fiber reinforced aerogel composite. Furthermore, methods for insulating electronic devices such as, but not limited to, various fuel cells are described.

### PRIORITY

Priority is claimed to U.S. provisional applications 60/625,384 (filed Nov. 5, 2004) and 60/676,272 (filed Apr. 29, 2005) both hereby incorporated by reference in their entirety.

### FIELD OF INVENTION

The present invention relates to insulation of electronic devices, and specifically to insulated fuel cells and methods of achieving the same.

### SUMMARY

Embodiments of the present invention describe an insulated electronic device comprising a heat generating component at least partially covered with at least one layer of a fiber reinforced aerogel composite and methods of achieving the same. Furthermore, methods for insulating electronic devices such as, but not limited to, various fuel cells are described.

### DESCRIPTION

Fuel cells can release large quantities of heat when generating electric energy during operation. Typical PEMFC and DMFC fuel cells at 25° C., 1 atmosphere have a free energy of about −285 kJ/mole and about −726 kJ/mole respectively; illustrating that a significant quantity of heat can be released from fuel cells. The release of such thermal energy can negatively impact the sensitive components that are in the vicinity of, or connected to the fuel cell. Aside from potential harm to sensitive components, this thermal energy can also cause discomfort for the device user. Such issues become more apparent as a growing number of miniature fuel cells suitable for use with portable electronic products are becoming available today.

U.S. Pat. Nos. 5,364,711 and 5,432,023, describe miniature fuel cells that run on methanol employed in powering electronics, and U.S. Pat. Nos. 4,673,624 and 5,631,099 describe methods of forming fuel cells. U.S. Pat. No. 5,759,712 describes how a fuel cell can be packaged in a general hybrid systems power pack such as a battery, flywheel, or solar cells. It also describes porous gas manifolds and air gaps in the case of the power packs that act as both insulation and water control mechanism. Still, none of the aforementioned patents describe how to provide a high performance insulation system or a packaging which contributes to added efficiency of the devices, or both.

A typical fuel cell generates electrical energy from an electrochemical reaction. In addition to power generation, there is a considerable quantity of heat liberated during this process. In the case of typical Proton Exchange Membrane (PEM) fuel cells, higher operating temperatures thermodynamically favor larger power output. Such trends are further exemplified in direct methanol fuel cells (DMFC). Technical efforts such as in Dohle, H. et al. J. Power Sources, 111,268-282 (2002) present evidence that at higher temperature, power output of both a single cell and the fuel cell stack on the whole is enhanced. The motivation to operate such systems at higher temperatures is in apparent conflict with the notion of thermal management in devices powered by said fuel cell systems. In such devices, heat is generated in their normal course of operation and further heat from the fuel cell increases the temperature to levels that are not tolerated by the sensitive components of the devices that they power.

Aerogel composites can be employed to insulate the sensitive components of electronic devices from a proximal or integral heat source. Likewise, the surface of an electronic device, where a human comes in contact with said device, can be insulated from the heat source adding to comfort in use thereof. Particularly in the case of fuel cells where operating at elevated temperatures are of interest, aerogel composites are an excellent insulation solution. Accordingly, high temperature operating conditions can be maintained while isolation of said high temperatures from sensitive components and the user is achieved.

Aerogels describe a class of material based upon their structure, namely low density, open cell structures, large surface areas (often 900 m²/g or higher) and nanometer scale pore sizes. “Aerogels” refers to “gels containing air as a dispersion medium” in a broad sense and include, xerogels and cryogels in a narrow sense. Supercritical and subcritical fluid extraction technologies are commonly used to extract the solvent from the fragile cells of the material. A variety of different aerogel compositions, such as organic, inorganic and hybrid organic-inorganic can be prepared. Inorganic aerogels are generally based on metal alkoxides and include materials such as silica, carbides, and alumina. Organic aerogels include carbon aerogels and polymeric aerogels such as polyimide aerogels. When the solvent is removed by an atmospheric pressure process instead of a supercritical fluid process, the resultant materials are called xerogels.

Aerogels function as thermal insulators primarily by minimizing conduction (low density, tortuous path for heat transfer through the nanostructures), convection (very small pore sizes minimize convection), and radiation (IR suppressing dopants may easily be dispersed throughout the aerogel matrix).

IR suppressing dopants for opacification of aerogels include but are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

Fiber reinforced aerogel composites comprise an aerogel matrix and a fiber reinforcement phase. The fiber reinforcement phase can be in the form of chopped fibers, microfibers, battings, felts, mats, woven fabric, non-woven fabrics or combinations thereof. The fibers can be polymer-based or inorganic-based. Examples of such include but are not limited to fiberglass, polyester, carbon, polyacrylonitrile [PAN], O-PAN, quartz and a variety of others. Preferred structure of fibers is in the form of a batting and it is most preferred as a lofty batting.

Particularly useful aerogel composites for embodiments of the present invention are silica aerogels reinforced with a lofty fiber batting comprising a material such as polyesters, paraaramids, silica, quartz, ceramics, wool, boron, aluminum, steel, polyetherimide, polyimides, polyamides, polyether sulphone, leather, polyacrylonitrile, polyacrylics, oxidized polyacrylonitrile, carbon poly-metaphenylene diamine, polyparaphenylene terephthalamide, ultrahigh molecular weight polyethylene, novolid resins, polyetherether ketone, polyethylene, polypropylene, polybenzimidazole, polyphenylenebenzo-bioxasole, polytetrafluoroethylene and the like. Such composites typically exhibit thermal conductivities of about 11 mW/mK and higher. The temperature range for continuous use these aerogel composites is typically about 650° C. and below.

Fiber reinforced aerogel composites, depending on the form of fiber reinforcement, can conform to a variety of shapes. As a non-limiting example, aerogel composites with a lofty batting fiber reinforcement phase, herein refered to as a “blanket” form, can be bent around edges and round surfaces and shaped into boxes and a variety of other enclosures. Aerogel blankets as well as other fiber reinforced aerogel forms can be self attached or co-secured to anther blanket via adhesives, staples, tags, stitches, rivets, posts and other similar fastening means.

Insulation of fuel cells with aerogel composites allows keeping the fuel cells at higher operating temperatures which can yield higher power outputs. Furthermore, the heat-sensitive components of a device employing a fuel cell can be protected by insulating the fuel cell with an aerogel composite. Also, aerogel composites are very lightweight and do not increase the weight of the system appreciably. Moreover, the resistance to heat flow (R) for an aerogel is exceptionally high thereby requiring smaller thickness of the same. This is crucial to devices which require space conservation. Of course such benefits may at least in part extend to a variety of other heat generating components in electronic devices, and not just fuel cells.

Thermal management according to embodiments of the present invention can be applied to a variety of power sources such as lithium-ion, lithium polymer batteries and fuel cells of different kinds including, without limitation the following: direct fuel cells, Alkaline fuel cell, Polymer Electrolyte Membrane fuel cell, Direct Methanol fuel cell, Solid Oxide fuel cell, Phosphoric acid fuel cell, Molten Carbonate fuel cell, Regenerative fuel cell, Zinc Air fuel cell, and Protonic Ceramic fuel cell.

A fuel cell can be described as an electric cell, which converts hydrogen or hydrogen containing fuels directly into electrical energy. This process generates heat through the electrochemical reaction of hydrogen and oxygen in water. Currently there are 6 fuel cell types are available commercially and under developmental stage. Different types of electrolytes used in fuel cells define the differences between the types of fuel cells. These types of fuel cells are as follows:

1. Alkaline Fuel Cell (AFC)
2H₂+40OH⁻→4H₂O+4e⁻ Anode Reaction:
O₂+4e⁻+2H₂O→4OH⁻ Cathode Reaction:
2H₂+O₂→2H₂O Cell:

2. Polymer Electrolyte Membrane Fuel Cell (PEMFC)
H₂→2H⁺+2e⁻ Anode Reaction:
O₂+4e⁻+4H⁺→2H₂O Cathode Reaction:
2H₂+O₂→2H₂O Cell:

3. Direct Methanol Fuel Cell (DMFC)
CH₃OH+H₂O→CO₂+6H⁺+6e⁻ Anode Reaction:
3/2O₂+6H⁺+6e⁻→3H₂O Cathode Reaction:
CH₃OH+3/2O₂→CO₂+2H₂O Cell:

4. Solid Oxide Fuel Cells (SOFC)
H₂+O₂⁻→H₂O+2e⁻ Anode Reaction:
1/2O₂+2e⁻→O₂⁻ Cathode Reaction:
H₂+1/2O₂→H₂O Cell:

5. Phosphoric Acid Fuel Cell (PAFC)
H₂→2H⁺+2e⁻ Anode Reaction:
1/2O₂+2H⁺+2e⁻→H₂O Cathode Reaction:
H₂+1/2O₂+CO₂→H₂O+CO₂ Cell:

6. Molten Carbonate Fuel Cell (MCFC)
H₂+CO₃²⁻→H₂O+CO₂+2e⁻ Anode Reaction:
1/2O₂+CO₂+2e⁻→CO₃²⁻ Cathode Reaction:
H₂+1/2O₂+CO₂→H₂O+CO₂ Cell:

Further details of each fuel cell is summarized in Table 1. In addition to the types of fuel cells listed above, new generations are under investigation such as the regenerative fuel cell (RFC). RFC's would separate water into hydrogen and oxygen by a solar-powered electrolyser. Zinc-Air Fuel Cells (ZAFC) is very similar to PEMFC process, but refueling zinc may be more complicated. The Protonic Ceramic Fuel Cell (PCFC) is another addition to the fuel cells, which is based on a ceramic electrolyte material and typically operates at about 700° C.

### DESCRIPTION OF THE DRAWINGS

FIG. 1 Illustrates “Cold” side temperature measurements after a typical aerogel blanket is placed on a hot plate at 390° F. (200° C.)

FIG. 2 Illustrates an enclosure using an aerogel composite for integrated fuel cell insulation.

FIG. 3 Illustrates an aerogel composite wrapped around four sides of a fuel cell.

FIG. 4 Illustrates aerogel composite insulation placed on two sides of a fuel cell.

FIG. 5 Illustrates a model of direct methanol fuel cell for a Palm Pilot

FIG. 6 Illustrates a cross sectional view of a typical fuel cell with aerogel composite insulation.

FIG. 7 Illustrates multiple fuel cells stacked together with aerogel composite insulation.

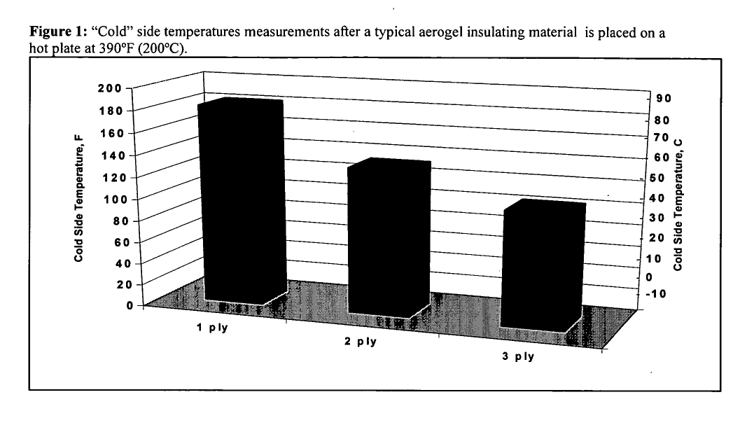

High operating temperatures are limiting factors for many applications. Depending on the operating temperatures of a fuel cell to be insulated, the type and thickness of the aerogel composite insulation should be selected. FIG. 1 illustrates the effect of aerogel composite thickness on surface temperature. For example doubling the thickness of aerogel composite can result in approximately 35% temperature reduction on the surface.

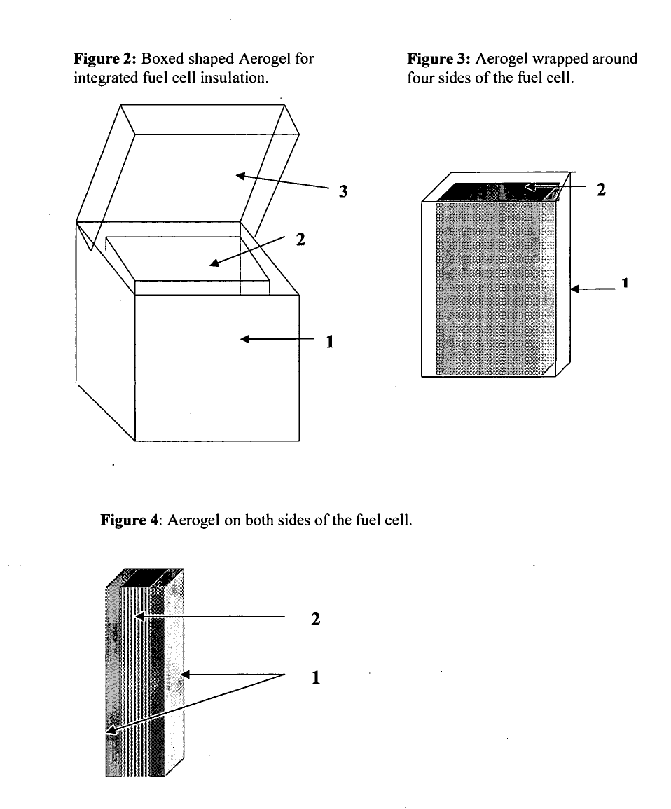

There are many different configurations in which one can apply insulating material to fuel cell. Among these, 3 basic types are described in FIGS. 2, 3 and 4. Of course an enormous array of configurations in addition to those described are possible and may be derived, at least in part, from the ensuing description of these figures. FIG. 2 shows aerogel composite layer(s), 1, formed into a box shape with a lid, 3. A fuel cell, 2, is placed in to the box. Of course, said box may have openings or orifices for engaging another device or for passage of wiring, fuel supply lines and other connectivities. Second type of insulation method is shown in FIG. 3 where the aerogel composite layer(s) 1, is wrapped around the fuel cell, 2, leaving two apposite sides open for connections or other purposes. Additional plies of aerogel composite, cut to desirable dimensions could be used for optional insulation of the open sides. The third simple insulation scheme is shown in FIG. 4 where aerogel composite layer(s) 1, are placed on two sides of the fuel cell, 2. Optionally, in the preceding arrangements, and indeed all other such arrangements the aerogel composite can be fastened to the fuel cell, to other structures residing in the vicinity of the fuel cell, or to an electronic device component of interest. Exemplary fastening means include but are not limited to adhesives, staples, tags, stitches, rivets, posts and other similar fastening means. The schemes as shown can be practiced individually or in any combination.

In one embodiment of the present invention, aerogel composites in conjunction with other supporting insulation material can be used. For instance, when a SOFC fuel cell is of interest, two or more types of insulating materials could be used to provide insulation. SOFC typically operates between about 600° C. to 1000° C. Here, a ceramic felt, ceramic paper or ceramic coating could be used cover the aerogel composite facing the fuel cell. In this manner, aerogel composites can be used in operating temperatures above what is recommended. Examples of a ceramic felt, ceramic paper and ceramic coating for high temperature applications are commercially available from Unifrax Corp.

Aerogel composite insulations can be applied to fuel cells and small devices in various configurations. Typical configurations are described in FIGS. 2, 3 and 4. A greater degree of encapsulation minimizes thermal bridges previously plaguing such designs. A typical example of a near-complete encapsulation is described in FIG. 2. However, such designs are only possible in integrated fuel cells, where fuel, air and waste management internal to the fuel cell. In fuel cell arrangements where fuel air supply, or waste water management, is outside the fuel cell packaging, an insulation package can be designed to allow for conduits for electrical leads, fuel supply, air supply, water outlet and other regular fuel cell operations. FIG. 8 shows a typical schematic of an integrated fuel cell. The cell comprises a cathode 3, anode 4, electrolyte 5, fuel supply 8, air supply 6, water supply 11, vent 7, thermal control (e.g insulation) 1, and fuel cell stack(s) 2. The fuel storage cartridge, 9, can be connected to a fuel supply 8, by using connections from outside of the integrated fuel cell package. The fuel storage cartridge 9, and water supply, 11, can be connected to the anode, 4, with using a pump, 10. Waste water can be recycled by moving it from cathode, 3, inside of fuel cell, 2, to water tank, 11. Air, 6, is supplied directly into the cathode, 3.

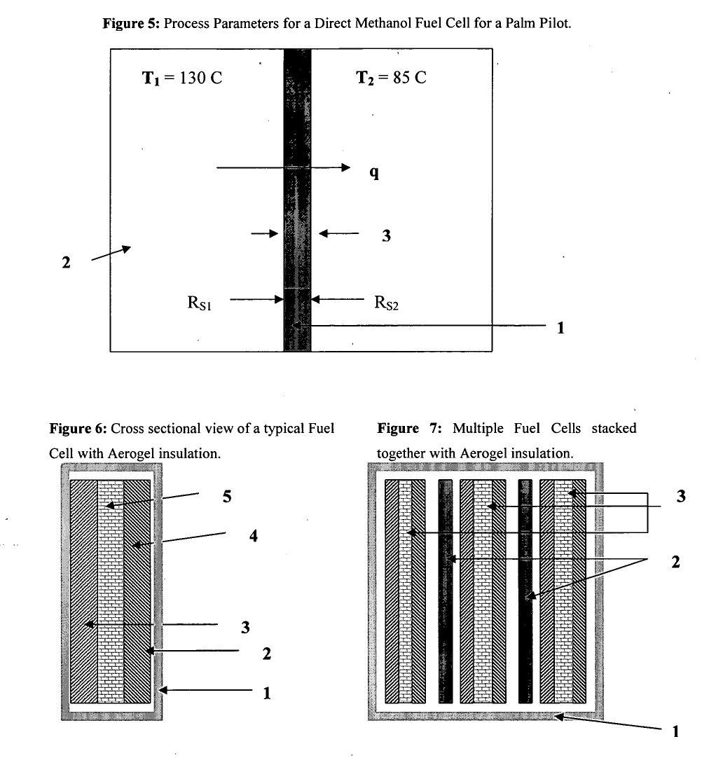

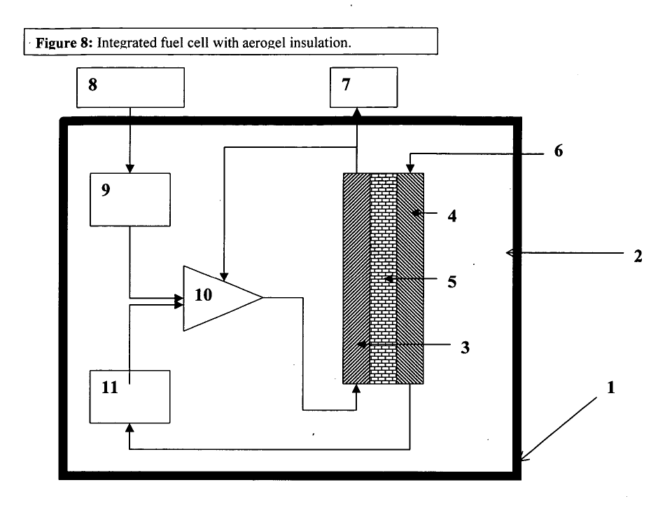

Fuel cells could be designed with single or multiple stack configurations, generically illustrated in FIGS. 6 and 7. FIG. 6 shows a cross sectional view of a single fuel cell, where electrolyte, 5, is assembled between cathode, 4, and anode, 3. The single stack fuel cell, 2, is then placed in an aerogel composite insulation package 1, or wrapped therewith. In a similar fashion, a multiple stack fuel cell 4, as shown in FIG. 7, can be placed in aerogel composite insulation package, 1. Here, each fuel cell is separated by using bipolar plates, 2.

The voltage generated from a fuel cell can be a gauge for the efficiency of the system. Lower voltage through a fuel cell will result in lower efficiency indicating that a greater amount of chemical energy has been transferred into heat. The reduction of cell voltage may be due to different reasons. For example energy required to initiate the electrochemical reactions often reduces the cell voltage. This could be resolved by optimizing the catalyst type, which will lower the activation energy required. The cathode reaction is about 100 times slower than the anode side. Allowing for higher operating temperatures, can increase this energy thereby overcoming the activation energy barrier. Lower operating temperatures will reduce the cell voltage. Whereas, insulating the fuel cell will maintain the operating temperatures at the desirable level.

Heat flow, Q, is the rate of heat moving from a higher temperature area to a lower temperature area. Heat flow is generally used to quantify the rate of total heat loss or gain through a system. Heat flux, q, is the heat flow through one square ft of area.

Accordingly:
q=Q/A, where A is the area.

The thermal conductivity, k, is the rate of heat flow through one inch of a homogeneous material. Thermal Resistance, R, is used to quantify the ability to minimize heat flow through the system.

These variables are related through the following equations:
R=k/L, where L is the thickness of the insulation.
Heat flux, q=(T₁−T₂)/(R_{S1}+(L/k)+R_{S2})

An example of process parameters for a typical direct methanol fuel cell for a palm pilot is illustrated in FIG. 5. For a 4 watt battery operating a palm pilot at 60% efficiency, the battery would be generating 6.7 watts (22.86 Btu/hr) of heat. Thermal conductivity of a typical aerogel composite 1, at mean temperature (81° F.) is 0.08 BTU in/hr ft² F.

Mean Temperature=(T₁+T₂)/2, where T₁ and T₂ are indicated in FIG. 5. T₁ is the operating temperature inside the fuel cell, 2, and T₂ is the designedoutside temperature. To obtain an estimation for the required thickness for the aerogel composite 1 the design basis for this example includes the following: The temperature differences between anode and cathode cells are negligible; the cathode is completely saturated with the gas mixture; the methanol reaching the cathode is completely oxidized and a one dimensional heat flow applies.

Under these conditions the thickness, 3, of aerogel, 1, required would be 0.175 inches or less. For comparison, a fiberglass batting insulation with typical thermal conductivity of 0.24 BTU in/hr ft2 F at 81° F., would require a minimum thickness of about 0.5 inches to achieve the same insulation value (R). When applying this example to small devices, the insulation may end up thicker than the device powering source, if not the thickness of the device itself. Hence, thinner insulation materials are desired.

In one embodiment the aerogel matrix in the aerogel composites of the present invention comprise a metal oxide such as but are not limited to: silica, titania, zirconia, alumina, hafnia, yttria and ceria.

In another embodiment, the aerogel matrix in the aerogel composites of the present invention comprise an organic material such as but are not limited to:, urethanes, resorcinol formaldehydes, polyimide, polyacrylates, chitosan, polymethyl methacrylate, a member of the acrylate family of oligomers, trialkoxysilylterminated polydimethylsiloxane, polyoxyalkylene, polyurethane, polybutadiane, a member of the polyether family of materials or combinations thereof.

In another embodiment, the aerogel matrix in the aerogel composites of the present invention comprise a hybrid organic-inorganic material such as but are not limited to:silica-PMMA (polymethylmethacrylate), silica-chitosan, silica-polyether or possibly a combination of the aforementioned organic and inorganic compounds. The published US patent applications 2005/0192367 and 2005/0192366 teach a whole host of such hybrid organic-inorganic aerogel materials along with their blanket forms useful in embodiments of the present invention.

In another embodiment the aerogel composite has at least one hydrophobic surface. This can accomplished by what is known as silylation process wherein alkyl groups are attached to for example the silicon backbone of a silica aerogel. Such attachments render the aerogel surface hydrophobic.

In one embodiment the aerogel composites are coated with epoxy, silicone, acrylic, polyurethane, polyvinyl chloride, polyvinylidene chloride, Ethylene vinyl acetate, polyolefins, natural rubber, styrene butadiene rubber nitrile rubber, butyl rubber, polychloroprene rubber, chlorosulphonated rubber, fluroelastomer based coatings or any combination thereof.

In one embodiment, the aerogel composites are fully encapsulated with a film or at least one layer(s) of a suitable material. Encapsulation can be achieved by lamination, spray coating, stitching or a combined procedure. Thermoplastic films, woven or nonwoven fabrics and combinations are typically used for laminating aerogel and xerogel insulating materials. Examples of suitable encapsulating materials include, but are not limited to: fiber glass cloth, silicon coated or Teflon coated fiber glass, polyimide film with and without glass reinforcement, metalized polyimide films, polymer coated Kevlar or glass cloths, nylons, polycarbonate, polyurethane films, aluminum, steel or copper films, polyolefin spun bonded films, ceramic and carbon cloths or any other woven or non-woven cloths. Additionally, various polyolefin-based films can also be used, such as, but not limited to:ethylene-vinyl alcohol (EVOH), ionomer, polymethylpentene (PMP), polyvinylidene chloride (PVdC), or polyvinyl alcohol (PVOH) films; Fluoropolymer films such as chlorotrifluoroethylene-vinylidene fluoride copolymer (PTCFE or CTFE-VDF), ethylene-chlorotrifluoroethylene copolymer (ECTFE), ethylene-tetrafluoroethylene copolymer (ETFE), fluorinated ethylene-propylene copolymer (FEP), perfluoroalkyl-tetrafluoroethylene copolymer (PFA), polyvinylidene fluoride (PVDF), and polyvinyl fluoride (PVF). Polyimide films include several types of polyimides made from monomers such as pyromellitic dianhydride and biphenyl tetracarboxylic dianhydride, crystal polymers (LCPs), polyethylene naph-thalate (PEN), polyketones (primarily polyetherether ketones or PEEK films), polysulfones (PSO, PES and PAS), polyetherimide (PEI), and polyphenylene sulfide (PPS). Polyarylates, thermoplastic elastomers (TPEs), poly-trimethylene terephthalate (PTT), benzocyclobutene (BCB), or cycloolefin copolymer (COC) films. Of course, any combination of the preceding films and layers may also be employed.

In another embodiment, an aerogel composites are encapsulated and sealed with epoxies, acrylates, silicones, hot melts, water based and solvent based adhesives, film and web adhesives stitching, heat seals, welding or any combination thereof.

In another embodiment, fire retarding agents are incorporated into the aerogel composite. This can be achieved by adding these agents to the aerogel matrix prior to gelation thereof.

In some embodiments, the aerogel composite insulations are combined with: aerogel monoliths, fiber reinforced aerogels, aerogel blankets, aerogel particles, aerogel beads, bound aerogel particles, bound aerogel particles reinforced with fibers, sticky aerogel beads, aerogel films, sticky aerogel beads reinforced with fibers, xerogel monoliths, fiber reinforced xerogels, xerogel blankets, xerogel particles, xerogel beads, bound xerogel particles, xerogel films, bound xerogel particles reinforced with fibers, sticky xerogel beads, sticky xerogel beads reinforced with fiber, laminated aerogels, encapsulated aerogels or any combination thereof.

In another embodiment, aerogel composites are maintained at reduced pressures. A barrier film can be used to encapsulate aerogel composites to maintain reduced pressures such as below about 10 Torr. The specific design of the film minimizes water vapor transport rate, thus making it a prime candidate for use as a vacuum barrier. Under reduced pressures, thermal conductivity of the aerogel composites significantly decreases thereby reducing the rate of energy (heat) transfer. This procedure can allow for even lower thicknesses for the aerogel composite.

In one embodiment, the fuel cells insulated with composite aerogels are components of devices such as, but not limited to: RF devices, laptop computers, PDAs, mobile phones, tag scanners, audio devices, video devices, display panels, video cameras, digital cameras, desktop computers, military portable computers, military phones, laser range finders, digital communication devices, intelligence gathering sensors, electronically integrated apparel, night vision equipment, power tools, calculators, radio, remote controlled appliances, GPS devices, handheld and portable television, car starters, flashlights, acoustic devices, portable heating devices, portable vacuum cleaners, portable medical tools and devices and possible combinations.

TABLE 1
Types of Fuel Cells

| | AFC | PEMFC | DMFC | SOFC | PAFC | MCFC |
|---|---|---|---|---|---|---|
| Operating | 90-100 | 60-100 | 80-130 | 600-1000 | 175-200 | 600-1000 |
| Temperature | | | | | | |
| (° C.) | | | | | | |
| Energy | | −285 kJ/mole at | −726 kJ/mole at | | | |
| output of | | 25 C. 1 atm | 25 C. 1 atm | | | |
| the reaction | | | | | | |
| Electrolyte | Aqueous | Solid Proton | Proton Exchange | Yttria | Liquid | Liquid |
| | Solution of | Exchange | Membrane | Stabilized | Phosphoric Acid | Solution of |
| | Potassium | Membrane made | (Nafion) | Solid Zirconia | Mixture | Lithium, |
| | Hydroxide | from Poly- | | | | Sodium, and/ |
| | Soaked in a | perflourosulfonic | | | | or Potassium |
| | Matrix | acid. (Nafion) | | | | Carbonates |
| | (caustic potash) | | | | | Mixtures |
| Catalyst | Nickel, | Thin Plastic coated | Catalyst coated | Perovskites | Platinum | Nickel |
| | Silver | with Platinum | membrane (CCM) | | | |
| Primary Fuel | | Methanol, Gasoline, | Methanol, | | Impure | Hydrogen, |
| | | Diesel or JP-8 | Gasoline, Diesel or | | Hydrogen | CO, Landfill |
| | | | JP-8 | | Or Gasoline | gas, Natural |
| | | | | | without Sulfur | Gas, |
| | | | | | | Marine diesel |
| % Fuel Cell | 55-60 | Less than 40 | 40 | 50-60 | 40-45 | 50-60 |
| Efficiency | | | | | | |
| Applications | Space travel | Electric utility | In Developmental | Large Scale | Electric Utility, | Electric Utility |
| | and submarine | Portable power and | Stage for small | Electric Utility | Transportation | |
| | engines. | Transportation | portable | | and Hospitals | |
| | | | applications. | | | |

What is claimed is:

1. An insulated electronic device comprising:
A heat generating component at least partially covered with at least one layer of a fiber reinforced aerogel composite.

2. The device of claim 1 wherein the heat generating component is a fuel cell.

3. The device of claim 1 wherein the aerogel composite is encapsulated, coated or both.

4. The device of claim 3 wherein the encapsulating material is polymeric.

5. The device of claim 3 wherein the encapsulating material is metallic.

6. The device of claim 4 wherein the polymeric material is a fluorinated polymer, a polyimide, a silicone based material, a polyamide-imide, a polyester-imide, a polyester-amide-imide, a polyphenylene oxide, polypyro-mellitimide of 4,4′-oxydianiline, polyamide-acid made from trimellitic anhydride and 4,4′-methylenedianiline, a polyetheretherbetone, a polyetherimide, a polyarylate, a polyetheretherketone, a polyetherimide a cyanate ester, or combinations thereof.

7. The device of claim 1 wherein the fiber reinforcement comprises a batting.

8. The device of claim 7 wherein the fiber reinforcement comprises a fiber based on polyester, oxidized polyacrylonitrile, carbon, silica, polyaramid, polycarbonate, polyolefin, rayon, nylon, fiber glass, high density polyolefin, ceramics, acrylics, fluoropolymer, polyurethane, polyamide, polyimide or any combination thereof.

9. The device of claim 1 wherein said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool.

10. A method of insulating an electronic device comprising:
at least partially covering a portion of a heat generating component within said device with at least one layer of a fiber reinforced aerogel composite.

11. The method of claim 10 wherein the heat generating component is a fuel cell.

12. The method of claim 10 wherein the aerogel composite encapsulated, coated or both.

13. The method of claim 12 wherein the encapsulating material is polymeric.

14. The method of claim 12 wherein the encapsulating material is metallic.

15. The method of claim 13 wherein the polymeric material is a fluorinated polymer, a polyimide, a silicone based material, a polyamide-imide, a polyester-imide, a polyester-amide-imide, a polyphenylene oxide, polypyro-mellitimide of 4,4′-oxydianiline, polyamide-acid made from trimellitic anhydride and 4,4′-methylenedianiline, a polyetheretherbetone, a polyetherimide, a polyarylate, a polyetheretherketone, a polyetherimide a cyanate ester, or combinations thereof

16. The method of claim 10 wherein the fiber reinforcement comprises a batting.

17. The method of claim 16 wherein the fiber reinforcement comprises a fiber based on polyester, oxidized polyacrylonitrile, carbon, silica, polyaramid, polycarbonate, polyolefin, rayon, nylon, fiber glass, high density polyolefin, ceramics, acrylics, fluoropolymer, polyurethane, polyamide, polyimide or any combination thereof.

18. The method of claim 10 wherein said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool.

19. A method of insulating a fuel cell comprising:
at least partially covering a fuel cell with at least one layer of a fiber reinforced aerogel composite.

20. The method of claim 19 wherein the aerogel composite is encapsulated, coated or both.

21. The method of claim 20 wherein the encapsulating material is polymeric.

22. The method of claim 20 wherein the encapsulating material is metallic.

23. The method of claim 21 wherein the polymeric material is a fluorinated polymer, a polyimide, a silicone based material, a polyamide-imide, a polyester-imide, a polyester-amide-imide, a polyphenylene oxide, polypyro-mellitimide of 4,4′-oxydianiline, polyamide-acid made from trimellitic anhydride and 4,4′-methylenedianiline, a polyetheretherbetone, a polyetherimide, a polyarylate, a polyetheretherketone, a polyetherimide a cyanate ester, or combinations thereof

24. The method of claim 19 wherein the fiber reinforcement comprises a batting.

25. The method of claim 24 wherein the fiber reinforcement comprises a fiber based on polyester, oxidized polyacrylonitrile, carbon, silica, polyaramid, polycarbonate, polyolefin, rayon, nylon, fiber glass, high density polyolefin, ceramics, acrylics, fluoropolymer, polyurethane, polyamide, polyimide or any combination thereof.
